(19) United States
(12) Patent Application Publication
(10) Pub. No.: US 2023/0368414 A1
(43) Pub. Date: Nov. 16, 2023

(54) PICK AND PLACE SYSTEMS AND METHODS

(71) Applicant: APERA AI INC., Vancouver (CA)

(72) Inventors: Sina AFROOZE, North Vancouver (CA); Aleksey Nikolai NOZDRYN-PLOTNICKI, Vancouver (CA)

(21) Appl. No.: 18/318,718

(22) Filed: May 16, 2023

Related U.S. Application Data
(63) Continuation of application No. PCT/CA2021/000101, filed on Nov. 17, 2021.
(60) Provisional application No. 63/114,962, filed on Nov. 17, 2020.

(51) Int. Cl. G06T 7/70; G06V 10/26; G06V 10/70; B25J 9/16

(52) U.S. Cl. CPC G06T 7/70; G06V 10/26; G06V 10/70; B25J 9/1697; B25J 9/1612; G06T 2207/10012; G06T 2207/20081

(57) ABSTRACT

A pick and place system comprises a computer connected to receive images of a field of view of a bin or other location at which objects are placed from disparate viewpoints. The computer is configured to process 2D image data of one or more of the images to determine a coarse pose and search range corresponding to the object. The computer is configured to perform subsequent stereo matching within the search range to obtain an accurate pose of the object. The computer is connected to control a robot to pick and place a selected object. Poses of objects may be determined asynchronously with picking the objects. Poses of plural objects may be determined and saved. the images may be processed to detect changes in the field of view. Saved poses for objects unaffected by changes may be used to pick the corresponding objects.

### CROSS-REFERENCE TO RELATED APPLICATIONS

This application is a continuation of Patent Cooperation Treaty application No. PCT/CA2021/000101 having an international filing date of 17 Nov. 2021, which in turn claims priority from, and for the purposes of the United States the benefit under 35 U.S.C. § 119 of, U.S. application No. 63/114,962 filed 17 Nov. 2020 and entitled PICK AND PLACE SYSTEMS AND METHODS. All of the applications referred to in this paragraph are hereby incorporated herein by reference for all purposes.

### FIELD

This invention relates to machine vision systems. Embodiments provide methods and apparatus useful for identifying poses of objects. The invention has example applications in the field of controlling robots to pick objects from bins.

### BACKGROUND

Various manufacturing and other processes involve the use of machine vision to identify poses of objects. An object's “pose” is information that specifies the position and orientation of the object. In general, the pose of a rigid object has six degrees of freedom. Three degrees of freedom in position (e.g. X, Y and Z coordinates of a reference point on the object) and three degrees of freedom in orientation (e.g. three angles that indicate pitch, yaw and roll relative to a reference orientation).

An example of such an application is controlling robots to pick up objects. A machine vision system may be positioned to view a heap of objects with the goal of identifying one object to be picked up next.

It can be challenging to identify individual objects and to determine their poses especially where the objects lack easily recognizable features or where the objects are mixed together in a heap of similar objects. These tasks are particularly challenging to execute in real time with realistic computational resources.

There is a general desire to reduce the necessary computation to identify objects and object poses by machine vision. There is also a general desire for quick object and object pose identification.

### SUMMARY

This invention has a number of aspects. These include without limitation:
machine vision systems adapted for determining object poses;
methods for determining poses of objects;
methods for determining robot poses to grip objects;
methods for picking and placing objects;
machine learning systems configured for recognizing and characterizing objects to be picked.
robotic pick and place systems.

One aspect of the invention provides a pick and place system that comprises a data processor connected to receive images of a field of view of a bin or other location at which objects are placed from disparate viewpoints. The images may for example be received from first and second cameras spaced apart from one another and oriented to obtain images of the field of view. As another example, the images may be obtained by one camera that is moved to capture images from different viewpoints. As another example, the images may be obtained by one camera and an optical system that is configurable to direct to the camera images from different viewpoints.

The data processor is configured to process 2D image data of one or more of the images to determine a search range corresponding to at least one object depicted in the one or more of the images. The data processor is configured to perform subsequent stereo matching within the search range to obtain an accurate pose of the object.

The data processor may be connected to control a robot to pick and place a selected object. Poses of objects may be determined asynchronously with picking the objects. In some embodiments the data processor is configured to determine both a coarse pose of the object and the search range for the object by processing the 2D image data. The data processor may use the coarse pose to reduce the computation required to obtain the accurate pose.

In some embodiments poses of plural objects are determined and saved. Additional images may be processed to detect changes in the field of view. Saved poses for objects unaffected by any changes may be used to pick the corresponding objects.

In some embodiments the system is able to select objects to be picked and provide poses for the objects as fast or faster than the robot can pick the objects. In such embodiments the robot may be controlled to pick objects continuously.

Another example aspect of the invention provides a method for determining a pose of an object. The method comprises: obtaining plural images of a field of view comprising one or more objects from plural viewpoints; and processing at least a first image of the plural images to identify one or more of the objects in the first image and to determine a search range corresponding to the object. The method performing stereo matching between the first image of the plural images and a second image of the plural images to determine an accurate pose of the object. The stereo matching is limited to the search range. In some embodiments the coarse pose is determined by a trained convolutional neural network (CNN). In some embodiments the methods comprises determining a coarse pose of the object by processing at least the first image of the plural images. The coarse pose may be used to obtain the accurate pose of the object more quickly.

Another aspect of the invention provides methods for estimating a coarse pose of an object. The methods comprise inputting a 2D image of the object to a machine learning system trained using real and/or synthetic images of the object in different orientations and applying the machine learning system to output the coarse pose. The coarse pose comprises both a 3D orientation of the object and a 2D pixel-space origin of the object.

In some embodiments the 3D orientation of the object comprises a closest anchor coordinate frame of a plurality of anchor coordinate frames that most closely matches the orientation of the object. For example, the method may comprise classifying the anchor coordinate frames (e.g. based on the probability that each of the coordinate frames is closest in orientation to the object). In some embodiments the classifying of the anchor coordinate frames is performed in a classification branch of the machine learning system. The classification branch may apply a convolutional neural network (CNN) featurizer comprising a fully-connected layer. The softmax function may be used to yield respective probabilities that the pose of the object matches each of the anchor coordinate frames.

In some embodiments the machine learning system is configured to provide a difference (delta) between the closest anchor coordinate frame and the pose of the object. The delta may, for example comprise Euler angles or quaternions.

In some embodiments determining the delta is performed by a delta regression prediction for the closest anchor coordinate anchor frame by the machine learning system. The machine learning system may, for example be a machine learning system that has been trained in a training method comprising, for each of a plurality of training images each depicting the object in a ground truth pose, training only delta branches of the machine learning system corresponding to a small number (e.g. three) of the anchor frames that are closest to the ground truth pose. In some embodiments the 3D pose comprises an identification of the closest anchor frame and the delta for the closest anchor frame.

In some embodiments the machine learning system implements Mask-R CNN comprising a ROI-pool layer and the method applies the ROI-pool layer as feature vectors input to a coarse pose regression which generates the coarse pose output.

In some embodiments the method comprises comprising converting an origin of the object from 2D pixel space (X,Y) to 3D space. Converting the origin of the object to 3D space may be done, for example, by determining a position for a mesh model of the object for which an origin of the mesh model is at least coarsely aligned with the origin of the object based on distances between points in a point cloud corresponding to the object and the mesh model.

In some embodiments the method comprises, by the machine learning system, regressing one or more pickability criteria for the object. In some embodiments the pickability criteria include relative occlusion of the object. The relative occlusion may be based on a proportion of an area of a mask for the object that is occluded by other objects.

In some embodiments the method comprises, by the machine learning system, regressing one or more pickability criteria for the object and using the ROI-pool layer as feature vectors input for regressing the one or more pickability criteria.

The object may be one of a plurality of objects depicted in the 2D image. For instance the 2D image may depict a collection of objects in a bin or otherwise available for picking by a robot. The method can include selecting one of the plurality of objects that is most suitable for picking and performing a more accurate 3D pose estimation for the selected object.

In some embodiments the selection is based on one or more of:
determining that the selected object is not occluded;
determining that the coarse orientation of the selected object is close to a preferred orientation for picking;
determining that a mask for the object is larger than those of other ones of the plurality of objects; and
determining that when a gripper of a robot is gripping the object at a picking location the gripper and robot are spaced apart from obstacles.

In some embodiments the 2D image is a primary image of a plurality of 2D images each corresponding to a different viewpoint and the method comprises calculating a depth of the object by stereo matching comprising calculating a disparity between a location of the object in the primary image and a location of the object in a secondary image of the plurality of 2D images. The stereo matching may be limited to the stereo matching range.

In some embodiments the stereo matching is based on overlap between bounding boxes for the object in the primary and secondary images. In some embodiments the method comprises creating feature vectors for the object in the primary and secondary images and the stereo matching is based on the feature vectors.

In some embodiments the stereo matching is limited to portions of the primary and secondary images corresponding to one or more object candidates selected for detailed processing.

In some embodiments the stereo matching comprises tiling a mask corresponding to the object in the primary image, calculating a corresponding tile in the secondary image for each tile in the primary image using the stereo matching search range, and performing the stereo matching for corresponding pairs of tiles in the primary and secondary images. The tiles may be equal in size. In some embodiments the tiles are on a fixed grid. In some embodiments the tiles are positioned so that a mask for the object is covered by a minimum number of the tiles.

Another aspect of the invention provides a machine learning system comprising a convolutional neural network trained to identify instances of an object in a 2D image and comprising a classification branch configured to classify a plurality of coordinate frames based on closeness to a 3D pose of an identified instance of the object. The classification branch may, for example comprise a convolutional neural network (CNN) featurizer comprising a fully-connected layer. The softmax function may be used to yield respective probabilities that the pose of the object matches each of the anchor coordinate frames. The machine learning system may further include a plurality of delta branches corresponding respectively to the plurality of coordinate frames wherein each of the delta branches comprises a delta regressor configured to determine a delta between the instance of the object and the corresponding coordinate frame. The machine learning system may be configured to enable only a small number (e.g. 1 to 6) of the delta regressors which correspond to those of the coordinate frames identified to being closest to the pose of the instance of the object by the classification branch.

Another example aspect provides apparatus configured to implement methods as described herein. The apparatus may, for example, comprise a computer configured by executable instructions which cause the computer to execute methods as described herein when the instructions are executed.

Further non-limiting example aspects of the invention are set out in the appended claims, illustrated in the accompanying drawings and/or described in the following description.

It is emphasized that the invention relates to all combinations of the above features with one another and with other features described in the following description and/or shown in the drawings, even if these are recited in different claims.

### BRIEF DESCRIPTION OF THE DRAWINGS

The accompanying drawings illustrate non-limiting example embodiments of the invention.

FIG. 1 is a schematic view showing an example pick and place system including an imaging target of interest (e.g. a bin of objects).

FIG. 2 is a high-level flow-chart showing an example algorithm for identifying an object to select for picking and how a robot should pick the object up.

FIG. 3 is a flow chart illustrating a method according to an example embodiment.

FIG. 3A is a flow-chart illustrating a method according to an example embodiment.

FIG. 4 is a high-level flow-chart showing a modified Mask R-CNN algorithm that may be applied to process images to provide information including coarse position and object masks.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

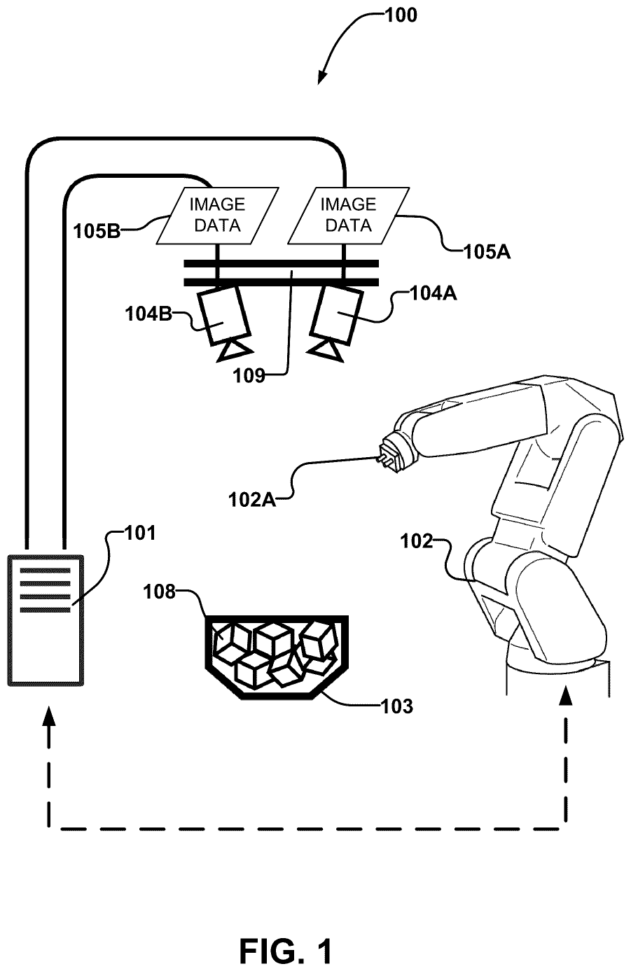

FIG. 1 depicts an example system 100. System 100 is an example of a pick and place robot system. System 100 may, for example, be applied to place objects 108 onto a machine tool or into a package or the like. In a typical application system 100 is controlled to pick one or more objects 108 from bin 103 and to place each of the one or more objects 108 onto a required corresponding location in a work holding system of a machine tool in a specific orientation. The machine tool then performs operations on the object(s) 108 during some cycle time. After every cycle of the machine tool, system 100 must pick one or more new objects 108 from bin 103 and place those objects at the required locations and in the desired orientations into the workholding system of the machine tool. The machine tool may, for example, comprise a computer controlled milling machine or lathe. In such applications it is desirable that system 100 operates quickly so that the machine tool is able to operate at full capacity.

System 100 comprises a robot 102 controlled by a computer 101 to pick objects 108 from a storage bin 103. Computer 101 processes images from two viewpoints to select objects 108 in bin 103 to be picked up and to determine poses of the selected objects 108.

In the embodiment illustrated in FIG. 1, system 100 includes cameras 104A and 104B (collectively or generally “cameras 104”). Cameras 104 are positioned so that objects 108 in storage bin 103 are in the field of view of cameras 104. Cameras 104 may, for example be located above and looking down into storage bin 103. In the example embodiment illustrated in FIG. 1, cameras 104 are attached to a frame 109.

Cameras 104A and 104B are spaced apart from one another such that they have different viewpoints of the objects 108 in storage bin 103 (i.e. cameras 104 are operable to generate stereoscopic images 105A, 105B—generally and collectively images 105). Cameras 104A and 104B each generates images 105 of objects 108 in storage bin 103 and provides the images 105 to computer 101.

The distance between cameras 104 may be selected to achieve a desired depth accuracy while leaving a desired distance between cameras 104 and bin 103. The exact distance between cameras 104 and the exact orientations of cameras 104 relative to one another and relative to bin 103 is not of critical importance. As long as cameras 104 have fixed and/or known positions and orientations a calibration process may be performed to allow images 105 from cameras 104 to be processed as described herein to determine with sufficient accuracy the locations and orientations of objects 108 to be picked.

It is generally desirable that cameras 104 are oriented such that y-axes of cameras 104 are approximately parallel (i.e. so that columns of pixels of cameras 104 are approximately parallel). It is usually convenient to locate cameras 104 to be relatively close to one another. Placing cameras 104 close together reduces the angle of view disparity between cameras 104. In some embodiments there is a small angle of view disparity (e.g. <5 degrees) between cameras 104).

As an alternative or in addition to plural cameras 104, system 100 may comprise a camera that is movable to obtain images from plural viewpoints. For example, system 100 may include one camera and a mechanism (e.g. a linear actuator, robot, linkage or the like) operable to move the one camera between the locations of cameras 104A and 104B in FIG. 1.

As another example, a camera 104 or two or more cameras 104 may be mounted on a movable part of robot 102. For example, the camera(s) 104 may be mounted to end of arm tooling (EOAT) of robot 102. Robot 102 may move the camera(s) 104 among plural positions to allow the cameras to obtain images of objects 108 from different viewpoints.

Images 105 may be preprocessed by a calibration routine which applies transformations to one or both of images 105 to facilitate stereo imaging. The calibration routine may, for example, do one or more of:
perform image rectification by digitally projecting images 105 into a common image plane (a “rectified plane”). The projected images appear as if the optical axes of cameras 104 are parallel. Image rectification may compensate for deviations of the optical axes of cameras 104 from being parallel.
apply transformations to correct for distortions created by the optical systems of cameras 104.
rotate images 105 so that rows of pixels in images 105 are parallel and columns of pixels in images 105 are parallel.
apply gamma correction to pixel values of images 105. For example, in some embodiments a gamma value of about 0.45 is used for gamma correction.

In embodiments in which images 105 are obtained using a mobile camera 104 (e.g. a camera 104 mounted to robot 102) then it is necessary to know the pose of the camera 104 corresponding to each image 105. In some embodiments the mobile camera is positioned in a predetermined pose for each image 105 (e.g. a pose provided by a specific configuration of robot 102). In some embodiments the pose of camera 104 that corresponds to an image 105 may be determined by one or more of: measuring and processing information that specifies a configuration of the mechanism (e.g. robot 102) that is positioning the camera 104 to take a particular image 105 and including in the field of view of the camera 104 when it takes a particular image 105 features that are at known locations and processing the image 105 to locate the features and to determine the pose of the camera 104 from the observed locations of the features in the image 105.

Preprocessing images 105 may beneficially provide preprocessed images 105 that allow stereo-matching for a pixel on a first preprocessed image 105 (a “primary image”) to be limited to pixels on a corresponding row of a second preprocessed image 105 (a “secondary image”). Such preprocessing is common and well understood in the field of stereo imaging.

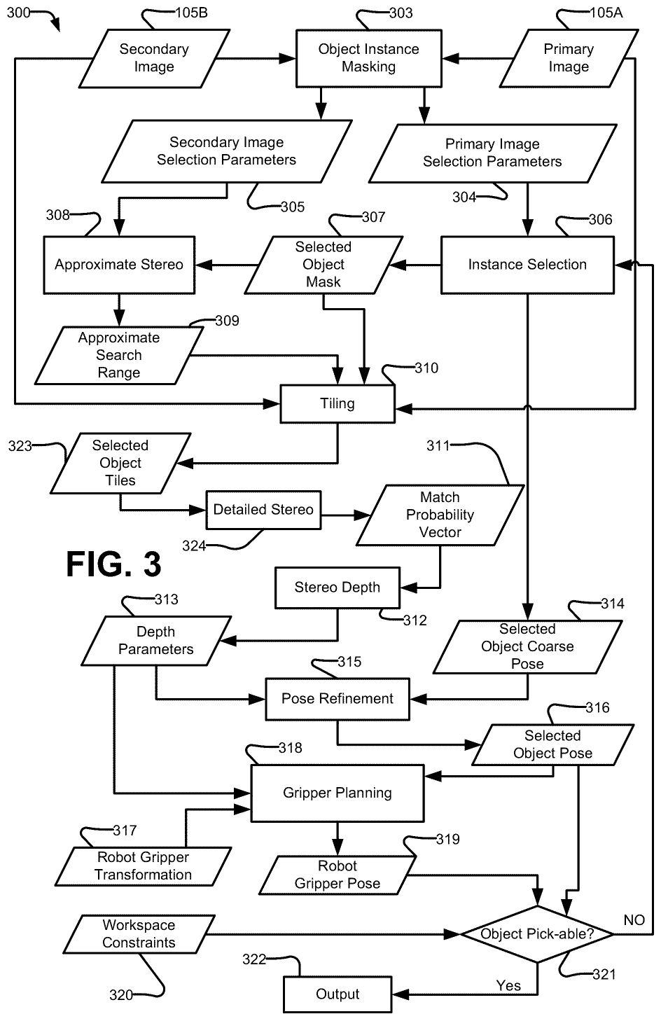

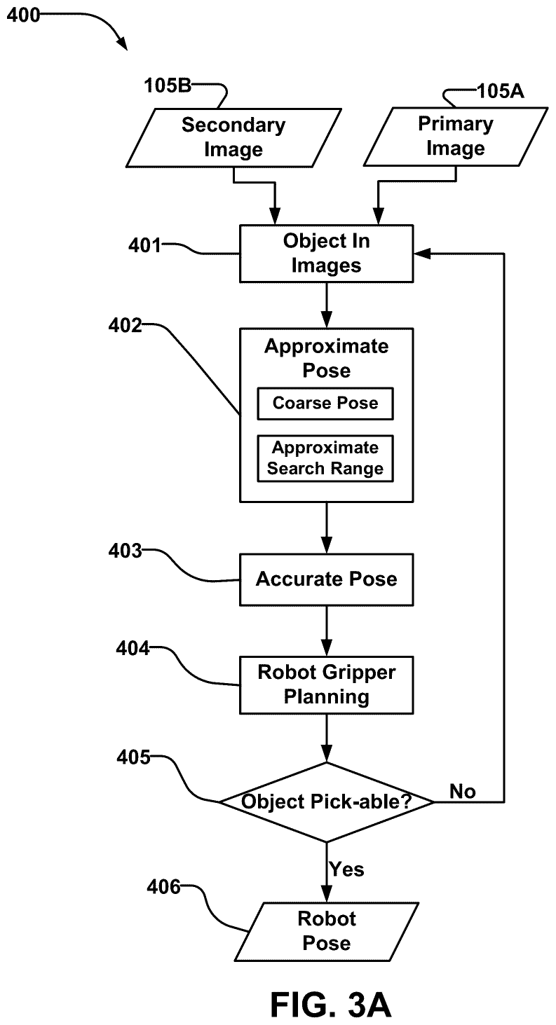

Computer 101 processes images 105, as transformed by the calibration routine, if present. For example, computer 101 may process images 105 from cameras 104 by method 300 discussed below (see FIG. 3). Based on the processed images 105 computer 101 selects an object 108 in storage bin 103 to be picked up by robot 102. For many types of object 108 there is a specific part of the object 108 (a “grip location”) that system 100 is configured to grip with gripper 102A. In some embodiments system 100 may specify a plurality of grip locations for an object 108. In such embodiments, system 100 may be configured to select one of the grip locations to be gripped with gripper 102A. System 100 may be configured to grip the object 108 at the grip location with gripper 102A positioned at a specific orientation relative to the object 108. System 100 may store data specifying one or more allowable gripper orientations relative to object 108 for each grip location specified for the object 108.

Computer 101 may, for example, determine poses of one or more candidate objects 108. Computer 101 may be configured to select a particular candidate object 108 to be picked next based on factors such as:

whether the candidate object 108 is occluded by other objects (e.g. are other objects 108 on top of the candidate object 108). It is better that the candidate object 108 is not occluded.
whether the grip location of the object 108 is at a position that can be reached by gripper 102A and, in at least some cases, whether the object 108 is oriented so that the grip location of the object 108 can be reached by gripper 102A with gripper 102A at a required orientation relative to the candidate object 108.
whether there are other candidate objects 108 that are more convenient (e.g. are at locations where they can be picked more quickly given a current configuration of robot 102).

Robot 102 is controlled to pick up the selected candidate object 108 using the pose of the object 108 to properly position and orient gripper 102A of robot 102 to pick up the selected object 108.

Upon selecting an object 108 to be picked from bin 103 computer 101 may control robot 102 to pick up the selected object 108 from storage bin 103 and to do something with the object 108 (e.g. place the object 108 on a fixture of a machine tool, place the selected object in a package or compartment, etc.). As mentioned above, it is desirable that system 100 is operable to very rapidly perform the challenging task of identifying the next object 108 to be picked and determine the pose of that next object 108. This task is ideally completed in a time that is shorter than the time between picking one object 108 and the time that a next object 108 needs to be picked so that the next object 108 can be placed at the earliest time permitted by the overall process. For example, in some cases it is desirable for computer 101 to complete this task in the time taken for robot 102 to move gripper 102A from a point in bin 103 to a place location and back to a point in bin 103.

Computer 101 optionally comprises two or more components. For example, computer 101 may comprise a robot controller 101A configured to directly control robot 102 and an object selection and pose determination component 101B configured to process images 105 from cameras 104 and to pass the pose of a selected object 108 to robot controller 101A.

Cameras 104 comprise digital cameras. Images 105 may each comprise an array of image data. The image data may, for example comprise pixel values for individual pixels in an array of rows and columns of pixels.

Cameras 104 may comprise high pixel density cameras. For example, cameras 104 may have a pixel density sufficient that points that are 1 millimeter apart in a plane in bin 103 perpendicular to an optical axis of a camera 104 are separated by 5 or more pixels in an image sensor of the camera 104. For example, if bin 103 has dimensions of 30 cm by 30 cm and each camera 104 has an optical system that exactly images the entire area of bin 103 onto an image sensor then it is desirable that the image sensor have at least about 1500 by 1500 pixels (about 2.25 megapixels). High pixel density is advantageous because it may enable high stereo depth resolution (e.g. within 1 mm accuracy or better) even with a small angle of view disparity (e.g. <5 degrees) between cameras 104.

The focal length of the lens of cameras 104 may be chosen when taken together with the sensor size and sensor resolution to provide a desired pixel density of the scene. For example, as the distance between cameras 104 and objects 108 increases, a longer focal length may be used to maintain the desired pixel density.

In some applications it may be desirable for cameras 104 to capture specific spectral information. In other applications it is not required that cameras 104 have any particular spectral sensitivity. For example, in many applications where objects 108 are parts that are not coloured in any particular way (such as many industrial parts) cameras 104 may not require colour sensitivity. For such applications image data of images 105 may be monochrome image data with pixel values that represent light intensity in some range of wavelengths of visible and/or infrared light. For example, where objects 108 have different colours and/or are patterned with specific colours (such as some consumer parts) camera 104 may be colour sensitive and images 105 may comprise pixel values corresponding to different colours. As another example, where objects 108 are made of transparent materials, for example transparent plastic bottles, cameras 104 may comprise hyperspectral cameras and image data 105 may comprise pixel values for 3, 4 or more spectral ranges.

The optical systems of cameras 104 may include filters. For example, polarizing filters may be included in the optical paths of one or more of cameras 104. Polarizing filters may be particularly useful in cases where illuminating light is incident on the surface on which objects 108 are supported at an angle of 60 degrees or more to a vector normal to the surface. As another example, where it is desired that images 105 are infrared images, infrared filters may be provided to block some or all visible light.

Typically, for the methods described herein it is preferable for images 105 to be high quality images (images that have high resolution as described above, high contrast and high pixel depth (e.g. 10 or more bits per pixel)). In some embodiments cameras 104 comprise machine vision cameras having a brightness resolution of 12-bits or more. Such cameras may, for example have image sensors of 4 megapixels or 12 megapixels or 20 megapixels or more.

Cameras 104 may capture images 105 continuously at a set frame rate or on demand. Where cameras 104 are high-mega pixel cameras (e.g. 12MP or more) cameras may be connected to supply the data of images 105 to computer 101 via a high bandwidth data communication path (e.g. 5 or 10 Gigabit/s USB or Ethernet) to reduce the time required for image capture.

It is desirable that cameras 104 produce sharp (in-focus) images of objects 108 at any depth in bin 103. This may be achieved by providing cameras 104 with optical systems that have or are adjusted to have a depth of field and a focus point such that an object 108 at any elevation within bin 103 will be in focus. The depth of field provided by cameras 104 may be selected based on the depth of bin 103 and the distance of cameras 104 from bin 103. For deeper bins 103 a larger depth of field may be obtained by providing a smaller aperture (larger f-number). An f-number in the range of 4 to 8 will provide sufficient depth of field for many applications.

One aspect of the invention relates to a method for determining which object a robot should pick up from a bin and how it should do so. For example, where there are a large number of objects piled on top of one another it is generally beneficial to select an object that: is at or near a top of the piled objects; and, for which a gripping part of the object that is intended to be gripped by the robot is both exposed and has an orientation such that a gripper of the robot can engage the gripping part.

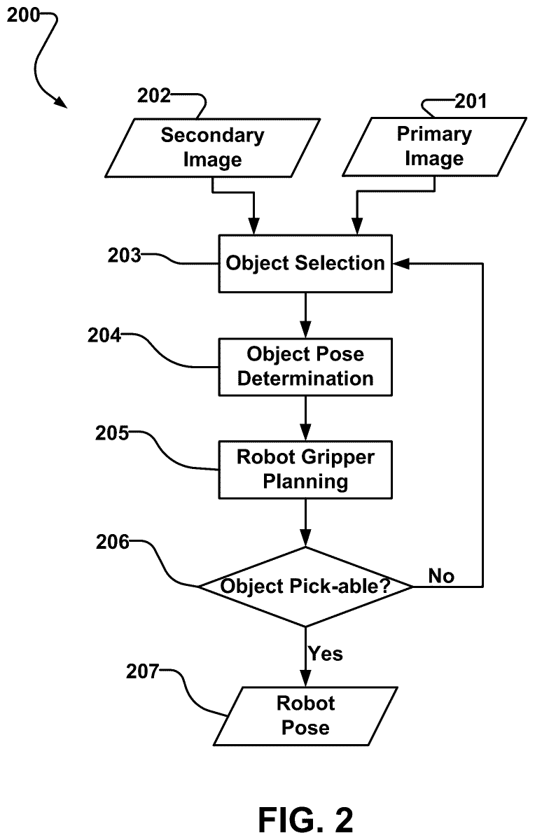

FIG. 2 is a flow chart for an example method 200. Method 200 comprises the steps of:
a) obtaining two images which show one or more objects within a target volume from different points of view. The images have overlapping fields of view. (see e.g. blocks 201 and 202);
b) picking one of the objects in the field of view to determine whether a robot (e.g. robot 102 described elsewhere herein) can pick the object up (see e.g. block 203);
c) determining the pose of the selected object (see e.g. block 204);
d) determining the robot pose that can grip the selected object (see e.g. block 205);
e) determining whether the robot can grip the selected object (see e.g. block 206); and
f) if the robot can grip the selected object providing the robot pose to a controller for the robot (see e.g. block 207), otherwise going through steps (b) through (f) for another object.

Block 206 may, for example consider the locations of obstacles such as the walls of bin 103 as well as the kinematics of robot 102.

FIG. 3 depicts method 300 for processing images 105 from cameras 104. Method 300 may be used, for example, to process image data in a pick and place process.

One feature of method 300 is that method 300 may select candidate objects for picking based on 2D information. The method determines a limited stereo matching range based on the 2D information. Once a candidate object for picking is selected stereo matching may be performed to determine a pose for the object. The computational cost of the stereo matching is reduced by limiting stereo matching to the limited stereo matching range for the selected object.

In some embodiments the candidate objects are selected using a trained convolutional neural network (CNN). Advantageously, processing by the CNN can be very fast. The outputs of the CNN may not be sufficiently accurate to pick the candidate object. However, the outputs of the CNN may dramatically reduce the time required for accurate stereo matching by providing the limiting stereo matching range for the selected object(s). The accurate pose of a selected object may then be determined by stereo matching within the limited stereo matching range. This process may be much less computationally intensive than finding the accurate pose by stereo matching over a significantly larger range or applying a technique that involves stereo matching over the entire image.

Another feature of method 300 is that method 300 optionally determines an approximate pose (which may be called a coarse pose estimate) of an imaged object using 2D image information. A candidate object for picking may be selected based in part on the approximate pose. The approximate pose may lack the degree of precision that may be desired or required to control a robot to pick the candidate object. However, the approximate pose may be determined very quickly. For example, a trained CNN may process an image 105 to yield the approximate pose. Using an approximate pose to select a candidate object for picking can facilitate rapid identification of candidate objects.

Object instance masking block 303 takes images 105A and 105B as inputs. In the following descriptions, one of images 105A and 105B is referred to as a “primary image” and the other one of images 105A and 105B is referred to as a “secondary image”. Either of images 105A and 105B may be the “primary image”. In the application, image 105A is referred to as primary image and image 105B is referred to as secondary image. That being said image 105A may be the secondary image and image 105B may be the primary image. Each of images 105 may be processed separately in object instance masking block 303.

Object instance masking block 303 finds portions of each image 105 that correspond to visible objects 108. Object instance masking block 303 outputs parameters that include locations of identified objects in images 105. In some embodiments the parameters output by object image masking block 303 include some or all of:
a number of object instances in the inputted image 105,
estimated masks that indicate what pixels of the image include the instance of the object 108,
classifications of each object 108 as being occluded (i.e. partially covered or blocked by one or more other objects 108) or non-occluded,
the relative size of the occlusion, as a ratio of an occluded area to an area of the entire object 108,
a mask of the occluded area of object 108,
type classifications of each object (in the case that the image depicts two or more different kinds of objects), and/or
coarse pose estimates for each object.

In some embodiments object instance masking 303 comprises downsampling an image 105. Performing object instance masking on downsampled images 105 has advantages including: object instance masking can be performed at much higher speed and where object instance masking is implemented with a CNN trained using synthetic data, operating at downscaled resolution may reduce the dataset domain gap between the synthetic training data and the inference data. The downsampling may, for example involve downsampling by a factor of 5 to 20 in each dimension (which correspondingly reduce the size of the images processed in object instance masking 303 by a factor in the range of 25 to 400. In some embodiments the downsampling is performed by a factor of about 10 in each dimension.

Where the parameters include plural classifications (e.g. classifications of object type and classifications that indicate whether an instance of an object is occluded) the parameters yielded by object instance masking block 303 may include combinations of two or more classifications. For example, occlusion and type classifications may optionally be combined into a single classification (e.g. objects may receive classifications such as type-A-occluded, type-A-non-occluded, type-B-occluded, type-B-occluded etc.).

In some embodiments object instance masking block 303 applies an AI-algorithm (e.g. a trained convolutional neural network) that takes images 105 as inputs and yields one or more parameters as outputs. The AI algorithm may be trained on images of actual piles of objects 108 and/or synthetically generated 2D training images depicting piles of objects 108.

Training data for object instance masking block 303 may comprise images of real objects labeled by expert humans or by image processing algorithms whose accuracy may be verified by humans. Training data may also or in the alternative include synthetic images rendered from 3D models of objects 108. It is also possible to create training images that are hybrids of actual images and synthetic data.

Synthetically generated 2D training images may be created based on 3D models of objects 108. For example, the synthetically generated 2D training images may be generated using ray-tracing. The synthetically generated training images may include elements that will be present in the fields of view of cameras 104 such as a bin 103. The synthetically generated 2D training images may be generated with various arrangements of objects 108 as well as various randomizations which may vary factors such as exposure, lens focal length, scene lighting, object color and texture, and scene background. The synthetic images optionally include one or more of: simulated backgrounds, randomized texturing of objects 108 and/or backgrounds, and scene lighting. Rendering engines such as Adobe Maya™, Unity™ or Blender™ may be used to produce synthetic images.

Object instance masking block 303 may be trained to be resilient to background changes by using a random selection of backgrounds in the synthetically generated 2D training images. Object instance masking block 303 may be trained to be resilient to lighting changes by providing synthetically generated training images which simulate an expected range of lighting conditions.

The training images may also contain labels that indicate the poses of depicted objects in one or more suitable coordinate frames. Such labels may be applied to train object instance masking block 303 to output coarse poses of objects in images 105. For synthetic training images the poses are known. For actual images used for training the poses of objects may be determined by staging objects in known poses, measuring poses of the objects and/or using stereo image processing or other techniques to determine poses of the objects in the training images. The poses of the objects in the training images may be determined in any suitable coordinate frame(s).

In method 300, instance object masking block 303 receives as inputs at least one image 105. For example, in one implementation object masking block 303 receives as inputs primary image 105A and secondary image 105B and respectively produces as outputs primary image selection parameters 304 and secondary image selection parameters 305.

In another example implementation, instance object masking block 303 processes one image 105 (e.g. primary image 105A) to identify one or more candidate object(s) and produces as output primary image selection parameters. In such implementations, the approximate stereo search range for each of the candidate object(s) may be determined by performing stereo matching between downsampled versions of the primary and secondary images 105A, 105B. Stereo matching can be much faster between downsampled images than it would be between full resolution images and may still be accurate enough to define an approximate stereo search range for an object candidate. For example primary and secondary images 105A, 105B may be downsampled by a factor of 10 in width and height dimensions before performing the stereo matching to establish the approximate stereo search range.

In another example implementation, downsampled versions of primary and secondary images 105A, 105B are processed to calculate an approximate depth map for the entire field of view. As above, the primary and secondary images may be downsampled by a suitable factor in each dimension (e.g. a factor in the range of 5 to 30 or a factor of about 10). The approximate depth map may be calculated before during or after instance object masking, block 303 processes primary image 105A to identify one or more object candidates.

Including approximate depth as input to instance object masking block 303 can be useful to improve selection of suitable candidate object(s). For certain objects the pose of the object maybe ambiguous from 2D image information only. For example, a 2D image looking at the concave face of a bowl-shaped object may look very similar or identical to a 2D image looking at the convex face of the same bowl-shaped object. Approximate depth information can disambiguate these views.

One way to use an approximate depth map is to supply the approximate depth map as input to a trained CNN together with one or more 2D images 105. During training of the object instance masking network, an approximate depth map may be created as described above.

In some embodiments object instance masking block 303 is implemented using a trained CNN. In some embodiments block 303 is implemented using a variant of the Instance-Masking Region-based Convolutional Neural Networks (Mask-R-CNN) algorithm. The Mask-R-CNN algorithm is described in Kaiming He et al., Mask R-CNN (available at: https://research.fb.com/wp-content/uploads/2017/08/maskrcnn.pdf) and K. He, G. Gkioxari, P. Dollár and R. Girshick, “Mask R-CNN,” 2017 IEEE International Conference on Computer Vision (ICCV), Venice, 2017, pp. 2980-2988, doi: 10.1109/ICCV.2017.322.

Mask R-CNN, extends the algorithm of Faster R-CNN. Faster R-CNN is described in Shaoqing Ren et al., Faster R-CNN: Towards Real Time Object Detection with Region Proposal Networks (available at: https://arxiv.org/abs/1506.01497) and S. Ren, K. He, R. Girshick and J. Sun, “Faster R-CNN: Towards Real-Time Object Detection with Region Proposal Networks,” in IEEE Transactions on Pattern Analysis and Machine Intelligence, vol. 39, no. 6, pp. 1137-1149, 1 Jun. 2017, doi: 10.1109/TPAMI.2016.2577031. Mask-R-CNN modifies Faster-R-CNN by adding a branch for predicting segmentation masks on each Region of Interest (RoI) in parallel with classification and bounding box regression.

Like Faster-R-CNN, Mask R-CNN performs a two step procedure. In the first step, Mask R-CNN proposes candidate object bounding boxes. In the second step, Mask R-CNN performs classification and bounding-box regression for each bounding box and also outputs a binary mask for each RoI.

An approximate depth map may be includes in Mask-RCNN by simply concatenating the depth map with the 2D image channels (RGB or Luminance) as input. Alternatively, other techniques, such as “Depth-aware CNN” (see https://arxiv.org/abs/1803.06791) may be used to replace the featurizer of Mask-RCNN.

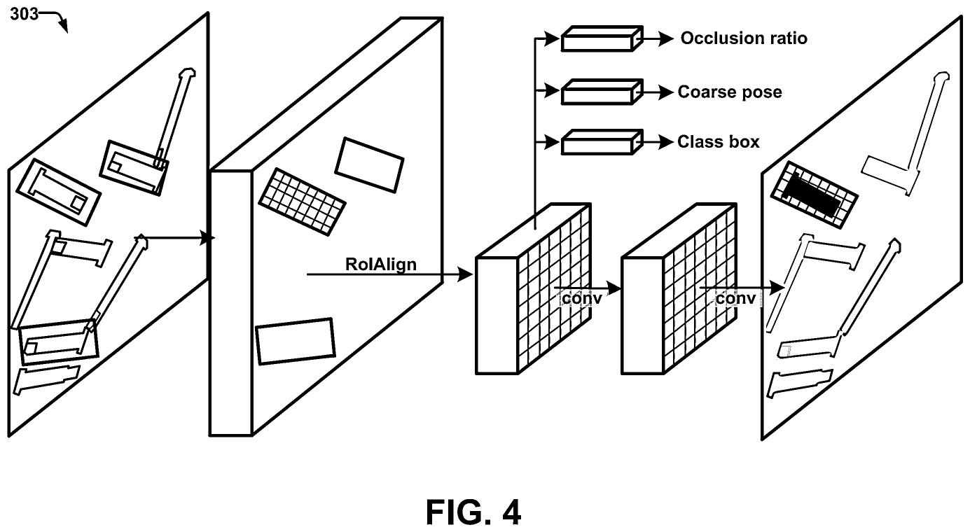

Object instance block 303 may extend Mask R-CNN by adding two additional fully connected branches for each ROI in parallel with the existing branches of classification, bounding box regression and instance masking (see e.g. FIG. 4).

One of the additional fully connected branches outputs an indication of whether or not an object in a ROI is occluded. In some embodiments this output is provided in the form of an occlusion value that indicates an amount of the object that is occluded. The occlusion value may be continuously variable or may have discrete allowed values.

In some embodiments the occlusion value is provided by an occlusion ratio. The occlusion ratio compares a total visible area of an object 108 in a ROI to areas of the object 108 that are occluded. For example, the occlusion ratio may be given by the ratio of an area of an object in the ROI that is occluded by another object to the total area of the object. With this formulation the occlusion ratio is in the range of 0 to 1 where an occlusion ratio of 0 indicates that the object 108 is not at all occluded and an occlusion ratio close to 1 indicates that the object is almost entirely occluded.

In some embodiments the output comprises an occlusion classification. The occlusion classification may, for example, have a first value such as 0 when the object is not occluded and a second value such as 1 when the object is occluded. In some embodiments the occlusion classification may have a first value indicating that the object in a ROI is too occluded to pick (e.g. because there are occlusions in or near a pick location on the object or more than a certain proportion of the area of the object is occluded) and a second value indicating that the object in the ROI is not too occluded to pick (e.g. because the object is not occluded or any occlusions are sufficiently far from the pick location and/or the occluded area is small relative to the size of the object). Occlusion classification may comprise applying a sigmoid function and a threshold to a variable such as occlusion ratio to produce a binary output (e.g. 0 or 1).

Another fully connected branch included in object instance block 303 outputs coarse pose. The coarse pose is a 3D orientation of the object and a 2D pixel space location of the object which may be origin projected to the image. Coarse pose may, for example, be specified as Euler angles or Quaternions. The coarse pose may be specified in any convenient coordinate frame (e.g. a coordinate frame associated with cameras 104, a coordinate frame associated with images 105, coordinate frame of a bounding box approximation of the object instance or an anchor coordinate frame). If anchor coordinate frames are used, an extra classification may be added to indicate the anchor coordinate frame used to specify the coarse pose of an object.

As part of the training data to create the appropriate labels for occlusion ratio the size of the mask of each object may be calculated, in number of pixels, both in the presence of other objects (A) and in the absence of any other object (B), the occlusion ratio may be defined, for example, as (B-A)/B.

In some embodiments the AI-algorithm in object instance masking block 303 uses rotated 2D bounding boxes as anchor boxes. Using rotated bounding boxes may advantageously reduce ambiguity introduced by the presence of overlapping long objects in the examined images. Computational resources are also conserved when processing rotated bounding boxes, as a greater proportion of the pixels processed are actually pixels of interest (i.e. pixels corresponding to an object instance).

The use of rotated bounding boxes (i.e. bounding boxes not constrained to have sides aligned with axes of the images) may reduce ambiguity by reducing the area surrounding an object that is included in the bounding box for the object. For example if the object has the form of an elongated cylinder oriented diagonally in the field of view of an image, a bounding box having sides aligned with x-y axes of the image would have an area significantly larger than the area occupied by the object itself. Ambiguity may be introduced by other objects also being present within the bounding box. In contrast, the use of rotated bounding boxes reduces the size of the bounding boxes which reduces the area included in the bounding boxes outside the objects bounded by the bounding boxes. This may in turn reduce ambiguity as to which object is associated with a bounding box.

An example of ambiguity that may be caused by axis-aligned bounding boxes is the case where two elongated objects are oriented diagonally to x-y axes with one of the objects lying across the other one of the objects. In this case a bounding box having sides parallel to the x-y axes for either of the objects could include the entirety of both of the objects. It would be ambiguous as to which one of the objects is the object of interest associated with the bounding box.

In embodiments where rotated bounding boxes are used the outputted selection parameters may further comprise parameters for a bounding box corresponding to each identified instance of an object 108. For example, the parameters for the bounding boxes may include:
bounding box dimensions (length, width);
bounding box angle (relative to a reference angle);
bounding box location (e.g. the location of a center or other reference point of the bounding box).

In some embodiments the bounding box parameters are determined by a convolutional neural network trained to output the bounding box parameters. The convolutional neural network may, for example comprise an angle regressor which is trained to output the bounding box angle. The convolutional neural network may include a box-center regressor trained to output the bounding box center location.

The bounding box angle and center location may, for example, be determined in the same manner that the Faster R-CNN algorithm determines bounding box angles and locations. For example, a set of anchor boxes with varying sizes and aspect ratios may be fit to objects in an image 105. The anchor box with the highest “abjectness score” may be used to “ROI pool” the anchor box. For each ROI, regression branches may be used to refine the center location, width, and height of a bounding box relative to the center and dimensions of the anchor box.

Some embodiments accommodate rotated anchor boxes. In such embodiments, anchor boxes with varying sizes, aspect ratios, and rotation amounts may be used. For each ROI, regression branches may be used to refine the center location, width, height, and rotation angle of a bounding box relative to the anchor center, dimension, and rotation angle of the anchor box.

In some embodiments object instance masking block 303 determines a coarse pose for each identified instance of an object 108. The coarse pose may, for example assume that first and second orthogonal axes of the object (e.g. a longitudinal axis and a transverse axis orthogonal to the longitudinal axis) are each aligned with an axis of an orthogonal coordinate frame in 3D space (e.g. a coordinate frame having orthogonal X, Y and Z axes). In this example case, there are six available directions for the first axis to be aligned along (positive and negative directions on each of three axes). There are then four choices of alignment of the second axis. This makes a total of 24 possible coarse orientations or “coordinate frames”. Other examples may provide more or fewer coordinate frames which represent available orientations for coarse poses. The coarse pose 2D pixel space origin may be estimated in the coordinate frame of the bounding box. For example, the 2D pixel space origin may be predicted as an offset from the box center in proportion to the height and width of the box.

Determining the coarse pose may comprise estimating which of the coordinate frames is closest to the actual orientation of the object 108. Object instance masking block 303 may select one of the coarse orientations that is closest to the orientation of each detected instance of an object 108.

In some embodiments a neural network used to implement object instance masking block 303 may output a coarse pose that includes identification of both one of a discrete number of coordinate frames and an estimated difference (“delta”) of the actual pose of the object from the pose corresponding to the identified coordinate frame. In such embodiments the delta may be determined by a pose refinement branch of the neural network.

When using a neural network for coarse pose estimation it is generally desirable to train the neural network to identify a coarse pose from among a reasonably large number of coordinate frames (e.g. 20 or more or 24 or more) because the difference in the actual orientation of an object from the closest coordinate frame will then be a small value, which is advantageous in inference with CNN architectures as a general rule.

In some embodiments a neural network operates to predict the probability that a coordinate frame is within some specified near threshold rotation magnitude of the object pose given that it is either within the near threshold or beyond a specified far threshold (where the far threshold is greater than the near threshold). The neural network may, for example be trained by constructing labels for binary cross entropy loss where “true” labels are coordinate frames within the near threshold, “false” labels are coordinate frames beyond the far threshold, and coordinate frames in between the near and far thresholds are ignored. At inference time, the coordinate frame with the maximum estimated probability is selected.

In cases where objects have symmetries, during training of the neural network, all the symmetric pose alternatives may be compared with each coordinate frame and the symmetric pose estimate closest to each frame can then be used for calculating training losses.

Object coarse pose 314 for an object includes 3D orientation and optionally includes an origin for the object. The origin may, for example, initially be defined in 2D pixel space (e.g. of primary images 105A). Various techniques may be applied to estimate the location of an object's origin in 3D for coarse pose. These techniques include, for example:
calculating a mean of the object's 3D points from a depth map;
converting an origin in 2D pixel space to a 3D origin for coarse pose by looking up the 3D coordinate of the object origin in 2D pixel space in depth parameters 313;
at least coarsely aligning a mesh model for the object with a point cloud of the object.

Determining a 3D origin for an object by aligning a mesh model for the object with a point cloud of the object may advantageously be resilient to noise and can handle objects with hollow centers. This can be done in 5 steps:
1. assign to the origin of the mesh model of the object the 3D coordinate given by (X, Y, f), where X and Y are the origin in 2D pixel space and f is the focal length of the relevant camera 104 in pixel units.
2. Define an origin view line, LO, for the object as the line passing through (0, 0, 0) and (X, Y, f).
3. For each of a selection of points P in the depth map of the object (i.e. depth map after applying the object's mask), calculate the intersection of the line MO passing through P parallel to LO. The selection of points may include all points, a set of randomly chosen points, a predefined set of points such as points on a fixed grid or the like. The depth map of the object may be down-sampled for performance reasons. For example the bounding box of the object can be sampled into a grid of n×n and the middle point of each grid cell may be used as a point if it belongs to the object's mask.
4. If the line MO in step 3 crosses any mesh triangles of the object's mesh, record the intersection that has the smallest value in z (i.e. depth).
5. In order to reject noise, sort all intersected z values and calculate the mean z_u of the middle k percentage of values. k for example can be in the range of 60% to 90%. For example, if k is 80% the top and bottom 10% values are rejected as outliers. The mean z may be called z_u.
6. Estimate the 3D origin for the coarse pose of the object as: (X*z_u/f, Y*z_u/f, z_u).

Instance selection block 306 receives primary image selection parameters 304 as an input. Instance selection block 306 uses primary image selection parameters 304 to pick one of the instance(s) of an object 108 identified in primary image 105A by object instance masking block 303 for further processing (e.g. to determine whether a robot 102 can pick up or not the object 108 correspondence to the instance).

Instance selection block 306 may, for example pick an object in primary image 105A using multi-step sorting based on one or more of: mask size, occlusion classification, closeness of the gripper's 2D projection mask at the pickpoint in image 105A to the edges of the mask of the selected instance or to the mask of other instances as a measure of likelihood of collision of the gripper with non-selected parts, and the closeness between the coarse object orientation and preferred robot orientations for the next pick.

For example a particular instance may be favoured for selection if:
the instance is classified as not occluded;
the coarse orientation for the object 108 seen in the instance is close to a preferred orientation for picking;
a 2D mask of the gripper is farthest from the instance's mask edges and/or from the mask(s) of other instances;
a distance of the robot and gripper at one of the picking options of the object in the coarse pose orientation is farthest away from obstacles such as the bin walls; and/or
the mask size is as large as possible.

For example, in some embodiments, instance selection block 306 operates by picking from primary image 105A a non-occluded object in the closest orientation to a preferred orientation that has a maximum mask size and possibly also where a gripper of robot 102, when positioned to grasp the object instance at an accessible pickpoint of the object instance is distanced from an edge of the instance mask and/or edges of masks of other object instances by a maximum distance or a distance that is at least equal to a threshold. A maximum mask size is preferable because a larger mask correlates with a larger visible surface area for a corresponding object in primary image 105A, which makes it more likely that pose refinement is accurate.

Preferred orientations may be specified in preference information stored in a data store accessible to computer 101. Preferred orientations may include a set of one or more reference poses. In such embodiments preference may be given to selecting objects for which the coarse poses are close to the reference poses

In some embodiments, instance selection block 306 outputs the object mask 307 and selected object coarse pose 314 (which may have been previously determined by object instance masking block 303).

Approximate stereo block 308 receives selected object mask 307 and secondary image selection parameters 305 as inputs. Approximate stereo block 308 uses selected object mask 307 and the masks of the objects in secondary image 105B to find an instance of an object 108 identified in secondary image 105B that corresponds to the instance of an object 108 in primary image 105A that has been selected by instance selection block 306.

In some embodiments, approximate stereo block 308 defines a candidate search region in secondary image 302 to find an instance of an object 108 that is also seen in primary image 105A based on a provided maximum search range for stereo matching. The maximum search range may be based on the geometry of cameras 104 as well as a volume within which all objects 108 are expected to be contained. All instances of objects 108 that are in the candidate search region in secondary image 105B may be selected and a stereo-matching score may be generated between each of the selected object instances in image 105B with the corresponding object instance in primary image 105A.

For each bounding box for an object identified in primary image 105A, approximate stereo block 308 attempts to identify one or more bounding boxes for objects identified in secondary image 105B that may be considered as a candidate stereo matching bounding box. The candidate stereo matching bounding boxes may be restricted to bounding boxes associated with secondary image 105B that are within a “match region” of the primary image bounding box being considered. The match region may be defined with reference to minimum and maximum possible depth of the scene. For example, the maximum depth of the scene may correspond to the floor of bin 103. The minimum depth of the scene may correspond to a top of bin 103.

Where there are two or more stereo matching bounding boxes in secondary image 105B, one of those images may, for example, be selected based on:
which one of the candidate stereo matching images has minimum overlap with the bounding box in the primary image after the bounding box in the primary image has been shifted along the x-axis of the image to best align on the secondary image bounding box; and/or
which candidate stereo matching bounding box is most similar to the primary image bounding box according to a similarity metric. Similarity may be determined using a stereo matching score. For example, the stereo matching score may use cosine similarity. The stereo matching score may, for example, be calculated by training a similarity score network to yield a similarity value within a suitable range. For example the similarity value may be in the range of 0 to 1 where 0 indicates least similarity and 1 indicates most similarity.

The stereo-matching scores may be based on feature vectors of the instances of objects. For example, a feature map may be prepared for an entire image 105. This may, for example be done by passing the image 105 through a convolutional neural network. A feature vector may then be generated for each instance of an object 108. In some embodiments the feature vector is generated by masking the features of the feature map using each object's mask and averaging local feature vectors within the area left unmasked by the mask. The stereo-matching scores may be determined by taking inner products of the resulting feature vectors.

For each bounding box ROI, a feature vector may be created. A feature vector may be created by averaging or finding the maximum of each feature of the feature vector within the ROI to create a single feature vector. Another way feature vectors may be created is through the addition of a separate branch that outputs a single feature vector for the ROI.

Approximate stereo block 308 may identify a corresponding stereo matching bounding box in secondary image 105B for each bounding box associated with primary image 105A. Every primary image bounding box may be uniquely mapped to either one bounding box of secondary image 105B or no bounding boxes of secondary image 105B if no match is found.

If approximate stereo block 308 finds that the same bounding box of secondary image 105B is associated with two different bounding boxes associated with primary image 105A then, the bounding box of primary image 105A that has the greatest similarity to the bounding box of secondary image 105B is mapped to the bounding box of secondary image 105B. The bounding box of primary image 105A that has a lower similarity with the bounding box of secondary image 105B may then be mapped to a different bounding box of secondary image 105B with which it has the next best match.

When corresponding instances for the same object 108 have been identified in primary image 105A and secondary image 105B, approximate stereo block 308 calculates the approximate distance of the selected object from cameras 104 and generates a search range 309 around the approximate distance within which the actual distance to the object 108 is expected to be found.

A stereo search range 309 may be determined in any of several ways. For example, stereo search range 309 may be determined from the disparity between the best matching object (highest stereo-matching score) in secondary image 105B and the selected object in primary image 105A. Another way to determine stereo search range 309 is by performing stereo matching on downsampled versions of images 105A and 105B, for example at downscaling factor of 10. Optionally the stereo matching is performed only for the region of the selected object. Stereo search range 309 may be selected to bracket the approximate stereo depth for the object determined by the stereo matching. Calculation of stereo matching on downsampled versions of images 105A and 105B can be very fast. Another way to determine stereo search range 309 is to perform stereo matching over the entire field of view of downsampled versions of images 105A and 105B to obtain a depth map and to then choose stereo matching range 109 to bracket a depth from the depth map that corresponds to an object instance determined in object instance masking block 303. In some such embodiments, the approximate depth map is provided as input to object instance masking block 303.

Stereo search range 309 may be used later in the method to calculate an accurate depth map of object 108, which can be used to refine the pose of an object 108, for example by detailed stereo matching. Limiting the search range to a subsection of the initial image (e.g. the smallest region of interest that contains one non-occluded object) may be advantageous to increase computational speed and reduce computational cost. The upper limit of the search range for a pixel in primary image 105A may be the width of secondary image 105B in pixels. The search range may also be limited by the availability of memory in computer 101.

Search range 309 may be used for accurate stereo matching as described below. Search range 309 may be based on one or more of:
approximate stereo depth (e.g. disparity as may be determined by distance between centers of associated bounding boxes in primary image 105A and secondary image 105B);
coarse orientation of the corresponding object 108;
user settings;
   Approximate stereo block 308 outputs search range 309.

Tiling block 310 tiles a portion of primary image 105A that corresponds to a selected instance of an object 108 with tiles of a predetermined size. Tiles may be processed in parallel to speed up method 300.

Tiling block 310 receives as inputs primary image 105A, secondary image 105B, selected object mask 307 and search range 309. Tiling block 310 may use primary image 105A and selected object mask 307 to assign tiles to cover the unmasked area of selected object mask 307 for primary image 105A. Tiling block 310 uses the search range 309 for the object instance in primary image 105A to select a matching tile in secondary image 105B for every tile in primary image 105A.

In some embodiments, tiling block 310 attempts to fit the entire mask of a selected object instance into a single tile. If the width or height of the single tile exceeds a predefined maximum tile size, tiling block 310 may split the single tile into smaller tiles and may further split the smaller tiles until the entire mask of the object instance is covered by tiles that do not exceed the maximum tile size. In some embodiments the maximum tile size comprises a maximum tile width and a maximum tile height that may be different from one another.

Each tile may, for example comprise a M by N array of pixels in primary image 105A. In some embodiments the tiles are square pixel arrays. For example, in some embodiments N and M have values in the range of 200 to 500 pixels. In some embodiments the sizes of tiles are selected to allow all pixels of a tile to be simultaneously processed by a GPU (graphics processing unit) of computer 101.

Tiling block 310 may identify an arrangement of tiles that cover the unmasked area of selected object mask 307 with the fewest number of tiles. Tiling block 310 may identify an arrangement of tiles that cover the unmasked area of the corresponding mask for secondary image 105B with the fewest number of tiles.

To cover the unmasked area with tiles an image may be segmented into a chessboard pattern and covered with tiles of the same size. Each tile with at least one unmasked pixel may be selected for downstream processing.

Using search range 309, for each tile assigned to selected object mask 307, tiling block 310 creates a matching tile in secondary image 105B.

Tiling block 310 outputs selected object tiles 323. Selected object tiles 323 includes the tiles assigned to selected object mask 307 for primary image 105A and the corresponding tiles for secondary image 105B.

In tiling block 310 the tiles may be a pre-determined size. The pre-determined tile size may be selected to achieve a balance between maximizing hardware utilization, minimizing processing of extra padding around individual tiles and capturing large enough local information for effective pose determination. In another example embodiment the tiles have variable sizes and tiling block 310 attempts to maximize a size of the tiles without exceeding pre-defined maximum tile width and height values.

The tiles may all be the same-size. Using same-size tiles allows for efficient batching of tiles to maximize hardware utilization (e.g. GPU).

Detailed stereo block 324 receives as an input selected object tiles 323. Using the tiles from the selected object instance in primary image 105A and the corresponding object instance in secondary image 105B, detailed stereo block 324 determines correspondences between pixels in primary image 105A and secondary image 105B. These correspondences correspond to locations of points on the imaged object 108 and can therefore be used to obtain an accurate estimate of the depth of the imaged object 108.

In some embodiments detailed stereo block 324 applies an AI-algorithm trained on real labeled data to calculate a match probability vector 311 for each pixel in the tiles of primary image 301. A training technique as described in Jure Žbontar and Yann LeCun, Stereo Matching by Training a Convolutional Neural Network to Compare Image Patches (which can be found here: https://arxiv.org/abs/1510.05970, and J. Žbontar and Y. LeCun, “Stereo Matching by Training a Convolutional Neural Network to Compare Image Patches,” in JMLR, vol. 17, no. 65, pp. 1-32, April 2016). may be applied.

In some embodiments detailed stereo block 324 applies an AI-algorithm trained on real and/or synthetic data to regress the disparity value for each pixel in the primary image tile. The disparity value corresponds to the amount of shift between a pixel in the primary image tile and its perfect match on the secondary image tile. For example, the techniques described in: Xuelian Cheng, Yiran Zhong, Mehrtash Harandi, Yuchao Dai, Xiaojun Chang, Tom Drummond, Hongdong Li, Zongyuan Ge, Hierarchical Neural Architecture Search for Deep Stereo Matching arXiv:2010.13501 [cs.CV] available at https://arxiv.org/abs/2010.13501 may be applied to regress the disparity value.

In some embodiments, an AI-algorithm trained on real and/or generic synthetic data can be fine-tuned using synthetic data of the object of interest. This fine-tuning step allows a neural network to adapt its output to intricacies of the shape of the object of interest.

An architecture of the AI-algorithm may vary depending on speed and accuracy requirements. An AI-algorithm similar to the ones described in Stereo Matching by Training a Convolutional Neural Network to Compare Image Patches by Jure Žbontar and Yann LeCun (which can be found here: https://arxiv.org/abs/1510.05970 and J. Žbontar and Y. LeCun, “Stereo Matching by Training a Convolutional Neural Network to Compare Image Patches,” in JMLR, vol. 17, no. 65, pp. 1-32, April 2016) or Look Wider to Match Image Patches with Convolutional Neural Networks by Haesol Park and Kyoung Mu Lee (which can be found here: https://arxiv.org/abs/1709.06248 and H. Park and K. M. Lee, “Look Wider to Match Image Patches with Convolutional Neural Networks,” in IEEE Signal Processing Letters, vol. PP, no. 99, pp. 1-1, 2016) may be used.

Detailed stereo block 324 outputs match probability vector 311. The length of match probability vector 311 is equal to the number of pixels in search range 309. Each element of match probability vector 311 is a match probability score between a pixel of image 105A and a pixel of image 105B that is within search range 309. For example, the match probability score may be a number in a range such as 0 to 1. A score of 0 may correspond to the case where the compared pixels do not match. A score of 1 may correspond to the case where the compared pixels do match.

Match probability vector 311 may be post processed to propagate probability vector of strong matches to its neighboring weak matches. For example, a technique as described in Heiko Hirschmüller, Stereo Processing by Semi-Global Matching and Mutual Information (which can be found here: https://core.ac.uk/download/pdf/11134866.pdf and H. Hirschmuller, “Stereo Processing by Semiglobal Matching and Mutual Information,” in IEEE Transactions on Pattern Analysis and Machine Intelligence, vol. 30, no. 2, pp. 328-341, February 2008, doi: 10.1109/TPAMI.2007.1166). may be used. This technique is based on the heuristic that discontinuities in a depth map of a scene (i.e. changes of more than 1 best-match disparity level between neighboring pixels) coincide with luminance edges. For each pixel the probability vectors of the four neighboring pixels (top, bottom, left, right) are filtered using a simple triangular filter normalized by the maximum value of each vector and added to the current pixel's probability vector.

Stereo depth block 312 receives match probability vector 311 as an input. Stereo depth block 312 uses match probability vector 311 to select the disparity with highest matching probability and calculate the depth of the selected object from the selected disparity using triangulation math and pre-determined stereo calibration parameters. Stereo depth calculation block 312 outputs depth parameters 313. Depth parameters 313 includes parameters for a depth map of the selected object in the broader scene. In some embodiments the depth map is converted to a point cloud.

Detailed stereo depth block 324 may be trained to be resilient to lighting changes and to work in an environment that is sufficiently lit for humans.

Pose refinement block 315 estimates the accurate pose of the selected object in comparison to the broader scene. In some embodiments, pose refinement block 314 receives as inputs selected object coarse pose 314 and depth parameters 313. Pose refinement block 315 may operate to estimate the accurate pose of the selected object in comparison to the broader scene in different ways depending on the information supplied as inputs. Pose refinement block 315 outputs an estimation of the accurate pose of the selected object as selected object pose 316.

In some embodiments, pose refinement block 315 determines the estimate of the selected object's pose based, for example, on the iterative closest point algorithm.

A coarse pose for the selected object is optionally provided to pose refinement block 315. The coarse pose may, for example, be determined by object instance masking block 303 as discussed above. In some embodiments, the coarse pose is pre-determined. For example, objects to be picked may be arranged in holders that present the objects in approximately a certain orientation (in which case the certain orientation may be set as the coarse pose) or the objects may be presented arranged in a certain orientation on a flat surface such as a pallet (in which case a known orientation taken by the objects when lying on a flat surface may be taken as the coarse pose).

Some embodiments apply other pose estimation techniques that do not rely on a coarse pose. For example, pose refinement block 315 may determine a pose for an object instance using techniques that estimate a pose from a point cloud for an object. An example way to determine pose from a point cloud which may be applied in the present technology is described in: B. Drost and S. Ilic, “3D Object Detection and Localization Using Multimodal Point Pair Features,” 2012 Second International Conference on 3D Imaging, Modeling, Processing, Visualization & Transmission, 2012, pp. 9-16, doi:10.1109/3DIMPVT.2012.53 which is available at. https://ieeexplore.ieee.org/document/6374971.

Another option is to estimate the selected object's pose using an AI-learned algorithm for registering two point clouds to one-another (e.g. a point cloud representing the known configuration of the object and a point cloud obtained from images 105. An example of such an AI-learned algorithm is described in Zi Jian Yew and Gim Hee Lee, “RPM-Net: Robust Point Matching using Learned Features” arXiv:2003.13479 [cs.CV] available at: https://arxiv.org/abs/2003.13479). Another option is to apply an AI-learned algorithm trained for registering a known memorized object to a point cloud. An example of such an algorithm is described in Yisheng He, Haibin Huang, Haoqiang Fan, Qifeng Chen, and Jian Sun “FFB6D: A Full Flow Bidirectional Fusion Network for 6D Pose Estimation” arXiv:2103.02242 [cs.CV] available at: https://arxiv.org/abs/2103.02242).

Pose estimation using a point cloud may have improved reliability when applied in the context of the present technology where the provided point cloud is segmented using a mask for a single object instance.

There may be one or more ways to grip any particular type of object 108 with a robot gripper. What these way(s) are depends on the construction of the robot gripper and the configuration of the object 108. One or more picking options may be defined for a particular type of object 108 and a particular robot system. For example, a robot gripper may have a pair of opposed fingers and one picking option may be to pick up an object 108 by grasping a specified part of the object 108 between the fingers. Whether this is possible in a particular case may depend on the pose of the object. For certain object poses it may not be possible to position the robot gripper to engage with the specified part of the object 108.

Gripper planning block 318 receives as inputs selected object pose 316, depth parameters 313, and robot gripper transformations 317 for each preferred picking option. Using selected object pose 316, depth factors 313 and robot gripper transformations 317 gripper planning block 318 chooses one picking option and calculates robot gripper pose 319 which is the pose from which the robot can pick up the select object. The picking options may be selected based on:
The priority of the griper pose; and/or
A previously defined gripper reference pose (e.g. picking close to the vertical direction); and/or
A gripper pose that results in the largest distance between the gripper (or other parts of robot 102 that could collide with boundaries of the bin) and the bin boundaries or other obstacles that the robot could collide with.
   Gripper planning block 318 outputs robot gripper pose 319. If there is no appropriate robot gripper pose 319, gripper planning block 318 returns to instance selection block 306.

Gripper pose priority for gripper poses associated with different picking options may be determined by computer 101. In some embodiments a robot controller 101A of computer 101 may be configured to determine gripper pose priority. In some embodiments, gripper poses that result in less complex movements for robot 102 later in operation may be prioritized over gripper poses that would require more complex movements for robot 102. An example of less complex movements are movements that do not require flipping a corresponding object 108.

A gripper reference pose may be defined based on the relative transformation of the gripper with respect to cameras 104, work table or bin 103. A graphical user interface tool that displays a 3D model for the gripper in the point cloud of the scene along with the 3D model of bin 103 may be used to define a gripper reference pose.

A gripper pose that results in the largest distance between gripper 102A and the boundaries of bin 103 (and any other obstacles that gripper 102A could collide with) may be selected to minimize the chance of a collision between gripper 102A or an object 108 being carried by gripper 102A and bin 103 or other obstacles.

Object pick-able block 321 receives as inputs robot gripper pose 319, selected object pose 316 and workspace constraints 320. Workspace constraints 320 may include parameters such as bin boundaries and limitations on robot reach. Object pick-able block 321 uses robot gripper pose 319, selected object pose 316 and workspace constraints 320 to score the selected object as pick-able or not pick-able. Object pick-able block 321 may use a 3D model of robot 102 to perform inverse kinematic calculations to confirm within a pre-defined threshold certainty that robot 102 has sufficient reach to pick the object 108.

If the selected object 108 is pick-able then object pick-able block 321 returns a corresponding robot gripper pose 319 to robot 102 in output 322. If the selected object 108 is not pick-able then object pick-able block 321 returns to instance selection block 306 to select a different object 108 to be picked. The different object 108 may, for example correspond to the next object instance based on sort-order by instance selection block 306.

In some embodiments, output 322 of object-pickable block 321 is provided as input to a motion-planning block that outputs a sequence of robot joint poses for moving gripper 102A from a known initial pose to the robot gripper pose 319 for gripping the object to be picked.

If no object in bin 103 is pick-able, the robot 102 is notified that none of the detected objects are pick-able and/or robot controller 101A may notify the operator, activate a shaking mechanism to move objects 108 in bin 103, and/or use robot 102 to shuffle the objects in bin 103.

Method 300 optionally applies the same backbone CNN to generate features that are used for bounding box detection, approximate stereo and/or full stereo matching by formulating the neural network training as multi-task learning. Doing so saves computation and may improve generalizability.

In some embodiments to accelerate pose estimation, method 300 may be executed for the next object while the current object is being picked. The next object's pose may be calculated asynchronously. In some embodiments a pose cache stores precomputed poses of objects 108 that could potentially be selected next for picking.

In embodiments with a pose cache when a next object pose request is received the pose cache may be checked. If the pose cache is invalid a new pose estimation cycle is started. Upon completion a second pose estimation cycle may be started to fill the pose cache. The object of the second pose cycle may be selected by first considering all objects with a minimum pre-determined distance from the previous object returned to the robot in the 2D image and then sorting based on occlusion, orientation and mask size. The minimum pre-determined distance creates a minimum separation between consecutive picks which may help reduce disturbance to the second object from the first object being picked.

If on a next object pose request the pose cache is valid the location of the object in the pose cache in new primary and secondary images is checked for any change. If no change is detected by a specified time (e.g. after a predetermined period or when the robot is readying to pick the next object), the cached pose may be returned and a new pose estimation cycle may be started to fill the pose cache for a subsequent request.

Thresholding the luminance difference between the previous and current images 105 may be used to calculate a change mask. A change mask represents the areas that are considered “changed” or “disturbed” from the last process. In selecting an object from the pose cache, the object pose should not overlap with the areas changed. A change mask may be used to prevent attempts to pick disturbed objects.

Another example way to determine if an object has been disturbed is to compare the bounding box of the object whose pose is stored in the pose cache in the original image and the bounding box of the object in the new image (e.g. by comparing the intersection over union of the bounding boxes in the old and new images). If the object has not been disturbed then one bounding box shall exist in new image whose intersection and union with the bounding box for the object in the old image will be the same, resulting in an intersection over union (IOU) value of 1. A threshold close to 1, for example 0.99, maybe used to determine if the object has been disturbed beyond a tolerance. If IOU is larger than the threshold, the object is considered not disturbed.

An AI based solution may optionally be used to calculate a change mask. For example, an AI solution similar to the one described in Engiang Guo et al., Learning to Measure Change: Fully Convolutional Siamese Metric Networks for Scene Change Detection by (which can be found here: https://arxiv.org/abs/1810.09111v3 and Enqiang Guo, Xinsha Fu, Jiawei Zhu, Min Deng, Yu Liu, Qing Zhu, Haifeng Li: Learning to Measure Change: Fully Convolutional Siamese Metric Networks for Scene Change Detection. CoRR abs/1810.09111 (2018)) may be used.

In some embodiments an object type may be identified in addition to the object's pose. For example, a bin of parts may include parts of two or more different types that may be picked. Identification of the type of the object may occur at stages such as object instance masking block 303. Where different types of objects are present object instance masking block 303 and/or instance selection block 306 may process only objects 108 of a currently required type.

In some embodiments initial identification of features in the images (e.g. object instance masking block 303) may comprise an AI-algorithm trained to generate axis-aligned or rotated bounding boxes of an object and another AI-algorithm trained to generate a mask of the scene (i.e. one mask of all objects in the scene). In such embodiments an approximate object mask may be created by intersecting one object bounding box and the mask of the scene mask.

In some embodiments initial depth approximation (e.g. approximate stereo block 308) may determine a similarity score for primary and secondary image patches or feature vector patches of object feature vectors based on the primary and secondary images. The similarity score may, for example, be determined by a trained artificial intelligence AI. For example, the similarity scores may be determined in the manner described in Jure Žbontar and Yann LeCun, Stereo Matching by Training a Convolutional Neural Network to Compare Image Patches by (which can be found here: https://arxiv.org/abs/1510.05970 and J. Žbontar and Y. LeCun, “Stereo Matching by Training a Convolutional Neural Network to Compare Image Patches,” in JMLR, vol. 17, no. 65, pp. 1-32, April 2016).

An example method 400 is shown in FIG. 3A. Method 400 obtains primary image 105A and secondary image 105B as inputs. In block 401 method 400 defines one or more objects found in each of images 105A and 105B. Block 401 may, for example, define the objects found in each of images 105A and 105B by means of object instance masking 303 as discussed herein.

Method 400 in block 402 determines an approximate pose of one or more objects found in one or both of images 105A and 105B. As part of determining the approximate pose of an object, block 402 may determine a coarse pose for the object 108 together with an search range for the object 108.

Advantageously block 402 processes one or more 2D images 105 and does not require stereo matching to yield the coarse pose or search range for the object. Block 402 may, for example, be performed by a trained CNN as described herein. The search range for an object 108 may, for example, be determined by means of approximate stereo 308 as discussed herein. The coarse pose for the object 108 may, for example, be determined by means of object instance masking 303 as discussed herein. Block 402 may perform other 2D image processing in addition or as an alternative. For example block 402 may be configured to identify fiducial points on an instance of an object 108 and to determine coarse pose and/or search range for the object 108 based on distances in an image 105 between the fiducial points.

In block 403 method 400 determines an accurate object pose. An accurate object pose may be determined by means of one or more of detailed stereo 324, stereo depth 312, and pose refinement 315 as discussed herein. The accurate object pose determination applies the search range determined in block 402 to limit the computations required to determine the accurate object pose for the object 108 (e.g. by limiting a range of stereo matching between images 105A and 105B to the search range determined in block 402.

In block 404 method 400 determines a robot pose for robot 102 to grip the object. Block 404 may, for example, be implemented through means of gripper planning 318 as discussed herein. Block 405 determines whether robot 102 can grip the object. Block 405 may be implemented, for example, through means of object pick-able 321 as discussed herein. If robot 102 can grip the object, method 400 controls robot 102 to pick the object using robot pose 406.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, and other devices suitable for the purposes described herein. Those skilled in the relevant art will appreciate that aspects of the system can be practiced with other communications, data processing, or computer system configurations, multi-processor systems, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention has a number of aspects. Non-limiting aspect of the invention comprise:
1. A method for determining a pose of an object, the method comprising:
   obtaining plural images of a field of view comprising one or more objects from plural viewpoints;
   processing at least a first image of the plural images to identify one or more of the objects in the first image and to determine a search range corresponding to the object;
   performing stereo matching between the first image of the plural images and a second image of the plural images to determine an accurate pose of the object wherein the stereo matching is limited to the search range.
2. The method according to aspect 1, wherein processing the plural images comprises processing the second image to identify the one or more of the objects in the second image.
3. The method according to aspect 1 or 2, wherein processing the plural images comprises:
   proposing a candidate bounding box for each of the one or more of the objects; and
   performing bounding box regression to determine bounding boxes for each of the one or more objects.
4. The method according to aspect 3 wherein the bounding boxes comprise rotated 2D bounding boxes.
5. The method according to any of the above aspects wherein processing the plural images comprises determining an occlusion value for the at least one object, the occlusion value indicating a degree to which the object is occluded.
6. The method according to any of the above aspects comprising processing one or more of the plural images to determine a coarse pose of the object.
7. The method according to aspect 6 wherein the coarse pose is a 3D orientation of the object specified as Euler angles or Quaternions.
8. The method according to aspect 6 or 7 wherein the coarse pose is measured relative to a coordinate frame of a corresponding one of the cameras.
9. The method according to any of aspects 6 to 7, wherein the coarse pose is measured relative to an anchor frame of reference.
10. The method according to aspect 6 or 7 wherein determining the coarse pose comprises downsampling two of the plurality of images to provide corresponding downsampled images and performing stereo matching between the downsampled images.
11. The method according to aspect 10 wherein the downsampling comprises downsampling by a factor in the range of 5 to 30 in each axis of the two of the images.
12. The method according to any of the preceding aspects comprising tiling the first image and the method comprises performing the stereo matching for tiles that include the at least one object.
13. The method according to aspect 12, wherein tiling the object comprises:
   dividing unmasked pixels in one of the camera images into tiles wherein each of the tiles is a M by N pixel array.
14. The method according to aspect 13, wherein M and N are in the range of 200 to 500 pixels.
15. The method according to any of aspects 12 to 14 wherein the tiles are equal in size.
16. The method according to any of the preceding aspects wherein determining the coarse pose of the object comprises:
   locating the object in the first image and the second image;
   calculating an approximate distance of the object from the cameras; and
   generating the search range around the approximate distance.
17. The method according to aspect 16, wherein locating the object in the first image and the second image comprises locating the object in the first image; based on the location of the object in the first image defining a match region in the second image; and
   searching the match region of the second image for the object.
18. The method according to aspect 17 wherein the at least one object comprises a plurality of objects and the method comprises defining a bounding box for each of the plurality of objects in the first image,
   for each of the bounding boxes in the first image identifying bounding boxes within the associated match region of the second image as candidate bounding boxes and selecting one of the candidate bounding boxes as a matching bounding box based on a similarity score to the bounding box of the first image.
19. The method according to aspect 18, comprising calculating the similarity score using cosine similarity.
20. The method according to aspect 18 or 19, comprising determining the similarity score using a trained similarity score network.
21. The method according to any of aspects 18 to 20 wherein the match region is determined based on a minimum and maximum depth of the scene.
22. The method according to any of the preceding aspects wherein the stereo matching comprises:
   generating a match probability vector;
   using the match probability vector to select a disparity with highest matching probability; and
   calculating depths of points on the selected object from the selected disparity using triangulation and pre-determined stereo calibration parameters.
23. The method according to aspect 22, comprising generating a depth map of the selected object in the broader scene based on the depths of the points.
24. The method according to aspect 23, comprising converting the depth map to a point cloud.
25. The method according to any of the preceding aspects comprising selecting one of the one or more objects to pick and controlling a robot to pick the object.
26. The method according to aspect 25 wherein the one or more objects comprises a plurality of objects and selecting the one of the objects is based on processing 2D image data of the first image.
27. The method according to aspect 26 comprising selecting the one of the objects based on a multi-step sorting.
28. The method according to aspect 27, wherein the multi-step sorting comprises sorting based on one or more of mask size, occlusion classification and the closeness between the coarse object orientation and one or more preferred robot orientations.
29. The method according to aspect 26 or 27 wherein the multi-step sorting comprises sorting based on a closeness of a 2D shape corresponding to a robot gripper griping the object to an edge of a mask of the object or a mask of one or more other ones of the plurality of objects.
30. The method according to any of aspects 27 to 28 comprising selecting one of the plurality of objects that is not occluded, has a coarse orientation close to a preferred orientation, and has a large mask size.
31. The method according to aspect 30 wherein the preferred orientation is defined in a data store.
32. The method according to any of aspects 25 to 31 comprising:
   determining a robot pose to grip the object;
   determining whether the robot can grip the object; and
   if it is determined that the robot can grip the object, controlling the robot to grip the object using the robot pose.
33. The method according to aspect 32 wherein determining the robot pose comprises:
   determining a best pose for the robot to grip the object; and
   determining whether the robot can grip the object.
34. The method according to any of aspects 25 to 33 comprising determining the pose of the object asynchronously with controlling the robot to pick the object.
35. The method according to any of aspects 25 to 34 comprising determining the pose for each of a plurality of objects; caching the determined poses;
   acquiring further images of the field of view and processing the further images to detect changes; and
   controlling the robot to pick one of the plurality of objects that is not affected by the changes using the corresponding cached pose.
36. An apparatus for picking and placing objects, the apparatus comprising:
   at least one camera arranged to obtain corresponding plural images of a field of view from corresponding plural viewpoints, the plural images including a first image, the field of view comprising one or more objects in a target volume;
   a robot arranged to pick up the objects from the target volume and to place the objects in a target area; and
   a data processor connected to receive the images and configured to process the images and to control the robot using a method according to any one of aspects 1 to 35.
37. The apparatus according to aspect 36 comprising a trained CNN configured to receive the first image as an input and to output a location of the at least one object and the search range.
38. The apparatus according to aspect 37 wherein the CNN is configured to output a coarse pose of the object.
39. The apparatus according to aspect 37 or 38 wherein the CNN is configured to output an occlusion value.
40. The apparatus according to any of aspects 37 to 39 wherein the CNN is configured to output coordinates of a reference point on the object.
41. A method for estimating a coarse pose of an object, the method comprising inputting a 2D image of the object to a machine learning system trained using real and/or synthetic images of the object in different orientations and applying the machine learning system to output the coarse pose comprising both a 3D orientation of the object and a 2D pixel-space origin of the object.
42. The method according to aspect 41 wherein the 3D orientation of the object comprises a closest anchor coordinate frame of a plurality of anchor coordinate frames that most closely matches the orientation of the object.
43. The method according to aspect 42 wherein the method comprises classifying the anchor coordinate frames.
44. The method according to aspect 42 wherein the classifying of the anchor coordinate frames is performed in a classification branch of the machine learning system that applies a convolutional neural network (CNN) featurizer comprising a fully-connected layer and applies the softmax function to yield respective probabilities that the pose of the object matches each of the anchor coordinate frames.
45. The method according to any of aspects 42 to 44 wherein the machine learning system is configured to provide a difference (delta) between the closest anchor coordinate frame and the pose of the object.
46. The method according to aspect 45 wherein the delta comprises Euler angles.
47. The method according to aspect 45 wherein the delta comprises quaternions.
48. The method according to aspect 45 comprising determining the delta by a delta regression prediction for the closest anchor coordinate anchor frame.
49. The method according to any of aspects 45 and 48 wherein the machine learning system is a machine learning system that has been trained in a training method comprising, for each of a plurality of training images each depicting the object in a ground truth pose, training only delta branches of the machine learning system corresponding to three of the anchor frames that are closest to the ground truth pose.
50. The method according to any of aspects 45 to 49 wherein the 3D pose comprises an identification of the closest anchor frame and the delta for the closest anchor frame.
51. The method according to any of aspects 41 to 50 wherein the machine learning system implements Mask-R CNN comprising a ROI-pool and the method applies the ROI-pool layer as feature vectors input to a coarse pose regression which generates the coarse pose output.
52. The method according to any one of aspects 41 to 51 comprising converting an origin of the object from 2D pixel space (X,Y) to 3D space.
53. The method according to aspect 52 wherein converting the origin of the object to 3D space comprises determining a position for a mesh model of the object for which an origin of the mesh model is at least coarsely aligned with the origin of the object based on distances between points in a point cloud corresponding to the object and the mesh model.
54. The method according to any of aspects 41 to 53 comprising, by the machine learning system, regressing one or more pickability criteria for the object.
55. The method according to aspect 54 wherein the pickability criteria include relative occlusion of the object.
56. The method according to aspect 55 wherein the relative occlusion is based on a proportion of an area of a mask for the object that is occluded by other objects.
57. The method according to aspect 51 comprising, by the machine learning system, regressing one or more pickability criteria for the object and using the ROI-pool layer as feature vectors input for regressing the one or more pickability criteria.
58. The method according to any of aspects 41 to 57 wherein the object is one of a plurality of objects depicted in the 2D image and the method comprises selecting one of the plurality of objects that is most suitable for picking and performing a more accurate 3D pose estimation for the selected object.
59. The method according to aspect 58 wherein the selection is based on one or more of:
   determining that the selected object is not occluded;
   determining that the coarse orientation of the selected object is close to a preferred orientation for picking;
   determining that a mask for the object is larger than those of other ones of the plurality of objects; and
   determining that when a gripper of a robot is gripping the object at a picking location the gripper and robot are spaced apart from obstacles.
60. The method according to any of aspects 41 to 59 wherein the 2D image is a primary image of a plurality of 2D images each corresponding to a different viewpoint and the method comprising calculating a depth of the object by stereo matching comprising calculating a disparity between a location of the object in the primary image and a location of the object in a secondary image of the plurality of 2D images.
61. The method according to aspect 60 wherein the stereo matching is limited to the stereo matching range.
62. The method according to aspect 60 or 61 wherein the stereo matching is based on overlap between bounding boxes for the object in the primary and secondary images.
63. The method according to aspect 60 or 61 comprising creating feature vectors for the object in the primary and secondary images and wherein the stereo matching is based on the feature vectors.
64. The method according to any of aspects 60 to 63 comprising limiting the stereo matching to portions of the primary and secondary images corresponding to one or more object candidates selected for detailed processing.
65. The method according to any of aspects 60 to 64 wherein the stereo matching comprises tiling a mask corresponding to the object in the primary image, calculating a corresponding tile in the secondary image for each tile in the primary image using the stereo matching search range, and performing the stereo matching for corresponding pairs of tiles in the primary and secondary images.
66. The method according to aspect 65 wherein the tiles are equal in size.
67. The method according to aspect 66 wherein the tiles are on a fixed grid.
68. The method according to aspect 66 comprising positioning the tiles so that a mask for the object is covered by a minimum number of the tiles.
69. Apparatus configured to perform a method according to any of aspects 1 to 68.
70. The apparatus according to aspect 69 comprising a programmed computer connected to control a robot having a gripper configured for gripping the objects.
71. Apparatus having any new and inventive feature, combination of features, or sub-combination of features as described herein.
72. Methods having any new and inventive step, act, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for determining a pose of an object, the method comprising:
obtaining plural images of a field of view comprising one or more objects from plural viewpoints;
processing at least a first image of the plural images to identify one or more of the objects in the first image and to determine a search range corresponding to the object;
performing stereo matching between the first image of the plural images and a second image of the plural images to determine an accurate pose of the object wherein the stereo matching is limited to the search range.

2. The method according to claim 1, wherein processing the plural images comprises processing the second image to identify the one or more of the objects in the second image.

3. The method according to claim 1, wherein processing the plural images comprises:
proposing a candidate bounding box for each of the one or more of the objects; and
performing bounding box regression to determine bounding boxes for each of the one or more objects.

4. The method according to claim 3 wherein the bounding boxes comprise rotated 2D bounding boxes.

5. The method according to claim 1 wherein processing the plural images comprises determining an occlusion value for the at least one object, the occlusion value indicating a degree to which the object is occluded.

6. The method according to claim 1 comprising processing one or more of the plural images to determine a coarse pose of the object.

7. The method according to claim 6 wherein the coarse pose is a 3D orientation of the object specified as Euler angles or Quaternions.

8. The method according to claim 6 wherein the coarse pose is measured relative to a coordinate frame of a corresponding one of the cameras.

9. The method according to claim 6 wherein the coarse pose is measured relative to an anchor frame of reference.

10. The method according to claim 6 wherein determining the coarse pose comprises downsampling two of the plurality of images to provide corresponding downsampled images and performing stereo matching between the downsampled images.

11. The method according to claim 10 wherein the downsampling comprises downsampling by a factor in the range of 5 to 30 in each axis of the two of the images.

12. The method according to claim 1 comprising tiling the first image and the method comprises performing the stereo matching for tiles that include the at least one object.

13. The method according to claim 12, wherein tiling the object comprises:
dividing unmasked pixels in one of the camera images into tiles wherein each of the tiles is a M by N pixel array.

14. The method according to claim 13, wherein M and N are in the range of 200 to
500 pixels.

15. The method according to claim 12 wherein the tiles are equal in size.

16. The method according to claim 1 wherein determining the coarse pose of the object comprises:
locating the object in the first image and the second image;
calculating an approximate distance of the object from the cameras; and
generating the search range around the approximate distance.

17. The method according to claim 16, wherein locating the object in the first image and the second image comprises locating the object in the first image; based on the location of the object in the first image defining a match region in the second image; and
searching the match region of the second image for the object.

18. The method according to claim 17 wherein the at least one object comprises a plurality of objects and the method comprises defining a bounding box for each of the plurality of objects in the first image,
for each of the bounding boxes in the first image identifying bounding boxes within the associated match region of the second image as candidate bounding boxes and selecting one of the candidate bounding boxes as a matching bounding box based on a similarity score to the bounding box of the first image.

19. An apparatus for picking and placing objects, the apparatus comprising:
at least one camera arranged to obtain corresponding plural images of a field of view from corresponding plural viewpoints, the plural images including a first image, the field of view comprising one or more objects in a target volume;
a robot arranged to pick up the objects from the target volume and to place the objects in a target area; and
a data processor connected to receive the images and configured to process the images and to control the robot using a method according to claim 1.

20. A method for estimating a coarse pose of an object, the method comprising inputting a 2D image of the object to a machine learning system trained using real and/or synthetic images of the object in different orientations and applying the machine learning system to output the coarse pose comprising both a 3D orientation of the object and a 2D pixel-space origin of the object.
